(19) United States
(12) Patent Application Publication
(10) Pub. No.: US 2023/0132215 A1
(43) Pub. Date: Apr. 27, 2023

(54) PROJECTION APPARATUS

(71) Applicant: Coretronic Corporation, Hsin-Chu (TW)

(72) Inventors: Ming-Ying Kuo, Hsin-Chu (TW); Tung-Chou Hu, Hsin-Chu (TW); Wei-Min Chien, Hsin-Chu (TW)

(73) Assignee: Coretronic Corporation, Hsin-Chu (TW)

(21) Appl. No.: 17/943,221

(22) Filed: Sep. 13, 2022

(30) Foreign Application Priority Data
Oct. 21, 2021 (CN) 202111226128.6

(51) Int. Cl. G03B 21/16; G03B 21/00

(52) U.S. Cl. CPC G03B 21/16; G03B 21/006

(57) ABSTRACT

A projection apparatus including a casing, a light source module, a light source heat dissipation module, an optical engine module, an optical engine heat dissipation module, and a projection lens is provided. The casing has an air inlet and an air outlet. The light source module is disposed in the casing. The light source heat dissipation module is disposed in the casing and connected to the light source module. The optical engine module is disposed in the casing and includes a liquid crystal panel. The optical engine heat dissipation module is disposed in the casing and connected to the liquid crystal panel. Airflow enters the casing from the air inlet, passes through the optical engine heat dissipation module and the light source heat dissipation module in sequence, and flows out of the casing from the air outlet. The projection lens is connected to the casing.

### CROSS-REFERENCE TO RELATED APPLICATION

This application claims the priority benefit of China application serial no. 202111226128.6, filed on Oct. 21, 2021. The entirety of the above-mentioned patent application is hereby incorporated by reference herein and made a part of this specification.

### BACKGROUND

### Technical Field

The invention relates to a projection apparatus, and particularly relates to a projection apparatus with a better heat dissipation effect.

### Description of Related Art

In addition to considering heat dissipation of a light source, projectors using a liquid crystal panel also have a certain demand for heat dissipation efficiency of the liquid crystal panel. It is a common practice for an optical engine to include a cavity to implement internal circulation of heat dissipation, where the cavity includes a liquid crystal panel, heat dissipation fins, and a fan. The fan dissipates the heat of the liquid crystal panel by forced convection and transfers the heat to the heat dissipation fins by air, but a heat dissipation effect thereof is limited. Moreover, in addition to a space required for configuring the heat dissipation fins and the fan, the cavity also needs an enough space to serve as an internal circulation channel for the air, which increases the volume of the optical engine.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection apparatus, which has a better heat dissipation effect.

Other objects and advantages of the invention may be further illustrated by the technical features broadly embodied and described as follows.

In order to achieve one or a portion of or all of the objects or other objects, an embodiment of the invention provides a projection apparatus including a casing, a light source module, a light source heat dissipation module, an optical engine module, an optical engine heat dissipation module, and a projection lens. The casing has an air inlet and an air outlet. The light source module is disposed in the casing and configured to provide an illumination beam. The light source heat dissipation module is disposed in the casing and connected to the light source module. The optical engine module is disposed in the casing and located on a transmission path of the illumination beam, and is configured to convert the illumination beam into an image beam. The optical engine module includes a liquid crystal panel. The optical engine heat dissipation module is disposed in the casing and connected to the liquid crystal panel. Airflow enters the casing from the air inlet, passes through the optical engine heat dissipation module and the light source heat dissipation module in sequence, and flows out of the casing from the air outlet. The projection lens is connected to the casing and configured to project the image beam out of the casing.

In an embodiment of the invention, the projection apparatus further includes a fan disposed in the casing and located adjacent to the air outlet. The airflow passes through the optical engine heat dissipation module, the light source heat dissipation module and the fan in sequence, and flows out of the casing from the air outlet.

In an embodiment of the invention, the fan has an axis, and in a direction of the axis of the fan, the light source heat dissipation module and the optical engine heat dissipation module are respectively overlapped with at least part of the fan.

In an embodiment of the invention, the optical engine heat dissipation module includes a base and a plurality of heat dissipation fins connected to the base.

In an embodiment of the invention, lengths of the heat dissipation fins are all equal, and an extending direction of the heat dissipation fins is perpendicular to at least a side of a frame of the liquid crystal panel.

In an embodiment of the invention, lengths of the heat dissipation fins are all equal, and the heat dissipation fins are disposed radially on a frame of the liquid crystal panel while taking the liquid crystal panel as a center.

In an embodiment of the invention, lengths of the heat dissipation fins are different, and an extending direction of the heat dissipation fins is perpendicular to at least a side of a frame of the liquid crystal panel.

In an embodiment of the invention, an area of the base is greater than an area of the liquid crystal panel.

In an embodiment of the invention, the liquid crystal panel includes a panel body and a circuit board. The panel body is disposed on the circuit board, a plurality of pads on the circuit board are exposed by the panel body. The base of the optical engine heat dissipation module is connected to the pads.

In an embodiment of the invention, the optical engine heat dissipation module includes heat dissipation fins and a plurality of bases. The liquid crystal panel includes a panel body and a plurality of metal blocks disposed on two opposite sides of the panel body. The bases are connected to the metal blocks.

In an embodiment of the invention, the heat dissipation fins are directly connected to the bases.

In an embodiment of the invention, the optical engine heat dissipation module further includes a plurality of heat pipes disposed on the bases. The heat dissipation fins are directly connected to the heat pipes and connected to the bases through the heat pipes.

In an embodiment of the invention, the projection apparatus further includes a thermal interface material disposed between the bases and the metal blocks.

In an embodiment of the invention, the light source heat dissipation module includes a base and a plurality of heat dissipation fins connected to the base, and the light source module is disposed on the base.

In an embodiment of the invention, the optical engine module has a first sealing part, and the optical engine heat dissipation module has a second sealing part. The first sealing part and the second sealing part are sealed, so that the optical engine module is connected to the optical engine heat dissipation module.

In an embodiment of the invention, one of the first sealing part and the second sealing part is a groove, and the other one of the first sealing part and the second sealing part is a protrusion.

In an embodiment of the invention, the projection apparatus further includes a sealing ring disposed between the first sealing part and the second sealing part.

In an embodiment of the invention, the projection apparatus further includes a buffer gasket disposed between the optical engine module and the optical engine heat dissipation module. The optical engine module has a first hole, the buffer gasket has a second hole, and the optical engine heat dissipation module has a third hole. A locking member passes through the first hole, the second hole, and the third hole in sequence to fix the optical engine module on the optical engine heat dissipation module.

In an embodiment of the invention, the casing has a first side and a second side opposite to each other, and a third side connected to the first side and the second side. The air inlet is disposed on the first side, the air outlet is disposed on the second side, and the projection lens is connected to the third side.

In an embodiment of the invention, the casing has a first side and a second side opposite to each other, and a third side connected to the first side and the second side. The air inlet is disposed on the third side, and the air outlet is disposed on the second side. The projection lens is connected to the third side and corresponds to the air inlet.

Based on the above description, the embodiments of the invention have at least one of the following advantages or effects. In the design of the projection apparatus of the invention, the optical engine heat dissipation module is connected to the liquid crystal panel of the optical engine module to dissipate the heat of the liquid crystal panel through heat conduction, which improves heat dissipation efficiency of the overall projection apparatus. In addition, the airflow may enter the casing from the air inlet, pass through the optical engine heat dissipation module and the light source heat dissipation module in sequence, and flow out of the casing from the air outlet, which means that the airflow may flow through all of the heat dissipation modules in the projection apparatus of the invention, so as to achieve the best heat dissipation effect.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a projection apparatus according to an embodiment of the invention.

FIG. 1B is a schematic diagram of a light path of the projection apparatus of FIG. 1A.

FIG. 1C is a three-dimensional schematic diagram of the projection apparatus of FIG. 1A.

FIG. 2A is a schematic diagram of an optical engine module and an optical engine heat dissipation module according to an embodiment of the invention.

FIG. 2B is a schematic diagram of an optical engine module and an optical engine heat dissipation module according to another embodiment of the invention.

FIG. 2C is a schematic diagram of an optical engine module and an optical engine heat dissipation module according to another embodiment of the invention.

FIG. 3A is a schematic diagram of an optical engine module according to an embodiment of the invention.

FIG. 3B is a schematic diagram of an optical engine heat dissipation module connected to the optical engine module of FIG. 3A according to an embodiment of the invention.

FIG. 4 is a schematic diagram of an optical engine module and an optical engine heat dissipation module according to another embodiment of the invention.

FIG. 5A is a partial cross-sectional schematic diagram of an optical engine module and an optical engine heat dissipation module according to another embodiment of the invention.

FIG. 5B is a schematic front view of FIG. 5A.

FIG. 6 is a schematic diagram of an optical engine module and an optical engine heat dissipation module according to another embodiment of the invention.

FIG. 7 is a schematic diagram of a projection apparatus according to another embodiment of the invention.

FIG. 8 is a schematic diagram of relative positions of a light source module, a light source heat dissipation module, an optical engine module, an optical engine heat dissipation module, and a fan according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

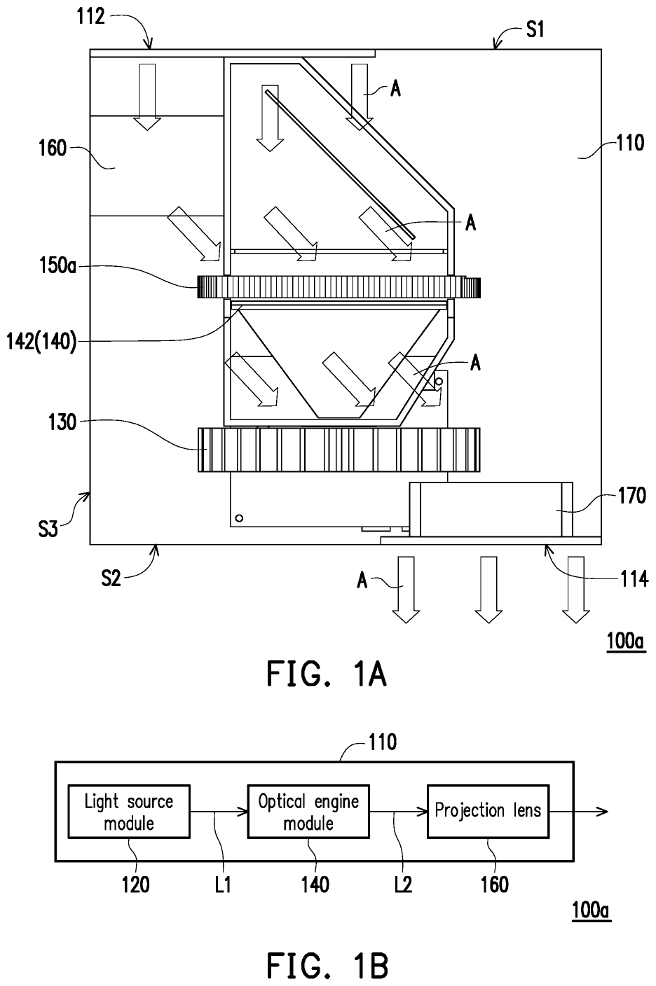

FIG. 1A is a schematic diagram of a projection apparatus according to an embodiment of the invention. FIG. 1B is a schematic diagram of a light path of the projection apparatus of FIG. 1A. FIG. 1C is a three-dimensional schematic diagram of the projection apparatus of FIG. 1A. For the convenience of description, FIG. 1C omits illustration of a casing.

Referring to FIG. 1A, FIG. 1B, and FIG. 1C at the same time, in the embodiment, a projection apparatus 100a includes a casing 110, a light source module 120, a light source heat dissipation module 130, an optical engine module 140, an optical engine heat dissipation module 150a, and a projection lens 160. The casing 110 has an air inlet 112 and an air outlet 114. The light source module 120 is disposed in the casing 110 and used to provide an illumination beam L1. The light source heat dissipation module 130 is disposed in the casing 110 and connected to the light source module 120. The optical engine module 140 is disposed in the casing 110 and located on a transmission path of the illumination beam L1 for converting the illumination beam L1 into an image beam L2, where the optical engine module 140 includes a liquid crystal panel 142. The optical engine heat dissipation module 150a is disposed in the casing 110 and connected to the liquid crystal panel 142. Particularly, an airflow A enters the casing 110 from the air inlet 112, sequentially passes through the optical engine heat dissipation module 150a and the light source heat dissipation module 130, and flows out of the casing 110 from the air outlet 114. The projection lens 160 is connected to the casing 110 and configured to project the image beam L2 to the outside of the casing 110. It should be noted that the airflow A may contact the optical engine heat dissipation module 150a and the light source heat dissipation module 130 to take heat away from the projection apparatus 100a. The air flow A does not directly contact the light source module 120 and the liquid crystal panel 142.

The light source module 120 of the embodiment is used to emit the illumination beam L1, which is converted by the liquid crystal panel 142 of the optical engine module 140, and then projected out of the projection apparatus 100a through the projection lens 160. The light source module 120 includes, for example, a light emitting diode, a laser diode or other suitable light sources. The projection lens 160 includes, for example, a combination of one or a plurality of optical lenses with refractive power, such as various combinations of non-planar lenses including a biconcave lens, a biconvex lens, a concavo-convex lens, a convexo-concave lens, a plano-convex lens, a plano-concave lens, etc. In an embodiment, the projection lens 160 may also include a planar optical lens to project the image beam L2 coming from the optical engine module 140 out of the projection apparatus 100a in a reflective or transmissive manner. Herein, a pattern and a type of the projection lens 160 are not limited in the embodiment.

Further, referring to FIG. 1C, in the embodiment, the light source heat dissipation module 130 includes a base 132 and a plurality of heat dissipation fins 134 connected to the base 132, and the light source module 120 is disposed on the base 132. Here, lengths of the heat dissipation fins 134 are all equal. In other embodiments, the heat dissipation fins 134 may also have unequal lengths, and are disposed radially around the base 132 while taking the base 132 as a center; or, the heat dissipation fins 134 may also have unequal lengths, and are disposed radially around the light source module 120 while taking the light source module 120 as a center. In addition, in other embodiments, the heat dissipation fins 134 have the same length and are disposed in a rectangular shape around the base 132, which are all within a protection scope of the invention.

Moreover, the optical engine heat dissipation module 150a of the embodiment includes a base 152a and a plurality of heat dissipation fins 154a connected to the base 152a, where the heat dissipation fins 154a are directly connected to the base 152a. Here, lengths of the heat dissipation fins 154a are all equal, and an extending direction of the heat dissipation fins 154a is perpendicular to at least a part of a frame of the liquid crystal panel 142. In other words, the liquid crystal panel 142 is rectangular-shaped, the extending direction of the heat dissipation fins 154a are perpendicular to at least one of the sides of the frame of the liquid crystal panel 142. As shown in FIG. 1C, an area of the base 152a is greater than an area of the liquid crystal panel 142, and the heat dissipation fins 154a are disposed in a rectangular shape.

In addition, referring to FIG. 1A and FIG. 1C at the same time again, the projection apparatus 100a of the embodiment further includes a fan 170, which is disposed in the casing 110 and is located adjacent to the air outlet 114. On a flow path of the airflow A, the fan 170 is disposed between the light source heat dissipation module 130 and the air outlet 114.

Furthermore, the casing 110 of the embodiment has a first side S1 and a second side S2 opposite to each other, and a third side S3 connected to the first side S1 and the second side S2. The air inlet 112 is disposed on the first side S1, the air outlet 114 is disposed on the second side S2, and the projection lens 160 is connected to the third side S3. Particularly, the airflow A sequentially passes through the optical engine heat dissipation module 150a, the light source heat dissipation module 130, and the fan 170 to flow out of the casing 110 from the air outlet 114. In other words, the projection lens 160 of the embodiment is placed upstream of a system flow field of the airflow A, and the optical engine heat dissipation module 150a and the light source heat dissipation module 130 are located at a midstream of the system flow field of the airflow A, and the fan 170 is disposed downstream of the system flow field of the airflow A, so that the overall projection apparatus 100a has a better heat dissipation effect. Moreover, it should be noted that the airflow A of the embodiment does not directly pass through the liquid crystal panel 142 and the light source module 120 in the enclosed cavity, but passes around the enclosed cavity. In other words, the airflow A in the embodiment only directly passes through the heat dissipation fins 154 of the optical engine heat dissipation module 150a, the heat dissipation fins 134 of the light source heat dissipation module 130, and the fan 170.

In brief, in the design of the projection apparatus 100a of the embodiment, the optical engine heat dissipation module 150a is connected to the liquid crystal panel 142 of the optical engine module 140 to dissipate heat generated by the liquid crystal panel 142 through heat conduction, which may improve the overall heat dissipation efficiency of the projection apparatus 100a. In addition, the airflow A may enter the casing 110 from the air inlet 112, sequentially pass through the optical engine heat dissipation module 150a and the light source heat dissipation module 130, and flow out of the casing 110 from the air outlet 114, which means that the airflow A may flow through all of the heat dissipation fins 134, 154a and the fan 170 in the projection apparatus 100a of the embodiment, so as to achieve the best heat dissipation effect.

It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

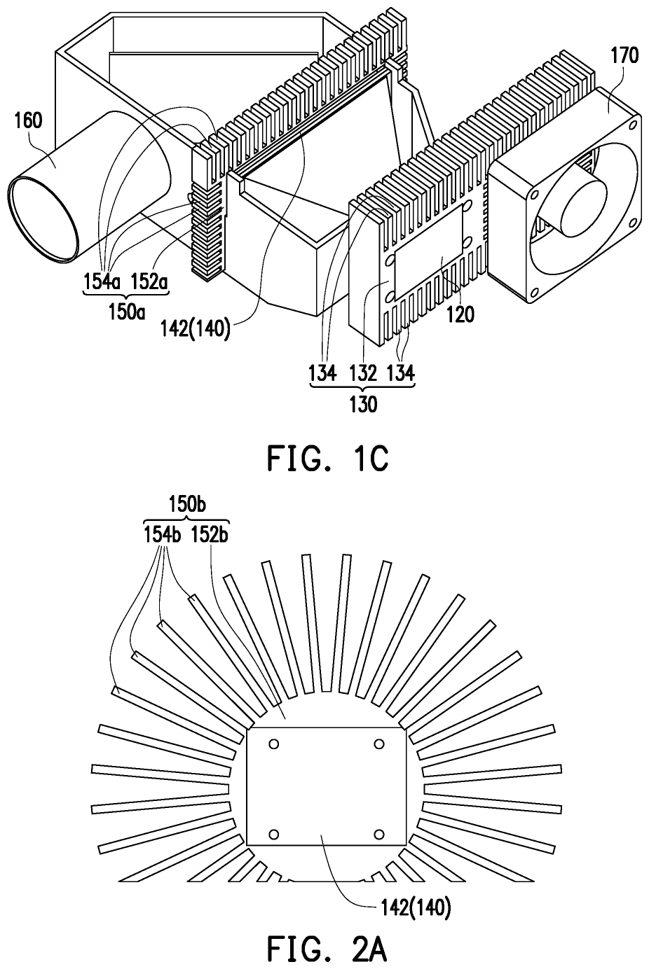

In the embodiment of FIG. 1C, the lengths of the heat dissipation fins 154a are equal, and the extending direction of the heat dissipation fins 154a is perpendicular to the frame of the liquid crystal panel 142. However, the embodiment is not limited thereto. FIG. 2A is a schematic diagram of an optical engine module and an optical engine heat dissipation module according to an embodiment of the invention. Referring to FIG. 1C and FIG. 2A at the same time, a difference there between is that in the embodiment, an optical engine heat dissipation module 150b includes a base 152b and a plurality of heat dissipation fins 154b connected to the base 152b, where the heat dissipation fins 154b are directly connected to the base 152b. Here, lengths of the heat dissipation fins 154b are all equal, and the heat dissipation fins 154b are disposed radially on a frame of the liquid crystal panel 142 while taking the liquid crystal panel 142 as a center.

FIG. 2B is a schematic diagram of an optical engine module and an optical engine heat dissipation module according to another embodiment of the invention. Referring to FIG. 1C and FIG. 2B at the same time, a difference there between is that in the embodiment, an optical engine heat dissipation module 150c includes a base 152c and a plurality of heat dissipation fins 154c connected to the base 152c, where the heat dissipation fins 154c are directly connected to the base 152c. Here, lengths of the heat dissipation fins 154c are different, and extending directions of the heat dissipation fins 154c are perpendicular to the frame of the liquid crystal panel 142, and the heat dissipation fins 154c are disposed in an arc profile on three sides of the liquid crystal panel 142, respectively.

FIG. 2C is a schematic diagram of an optical engine module and an optical engine heat dissipation module according to another embodiment of the invention. Referring to FIG. 1C and FIG. 2C at the same time, a difference there between is that in the embodiment, an optical engine heat dissipation module 150d includes a plurality of bases 152d1, 152d2 and heat dissipation fins 154d. The liquid crystal panel 142 includes a panel body 143 and a plurality of metal blocks 145 disposed on two opposite sides of the panel body 143. Namely, the metal blocks 145 are symmetrically disposed relative to a center of the panel body 143, where the metal blocks 145 may increase a contact area with the optical engine heat dissipation module 150d, thereby improving the heat dissipation efficiency. The bases 152d1 and 152d2 of the optical engine heat dissipation module 150d are connected to the metal blocks 145 through a thermal interface material 180a, thereby improving the heat dissipation efficiency. Namely, the projection apparatus of the embodiment may include the thermal interface material 180a disposed between the bases 152d1, 152d2 and the metal blocks 145 to connect the optical engine module 140 and the optical engine heat dissipation module 150d, thereby improving the heat dissipation efficiency.

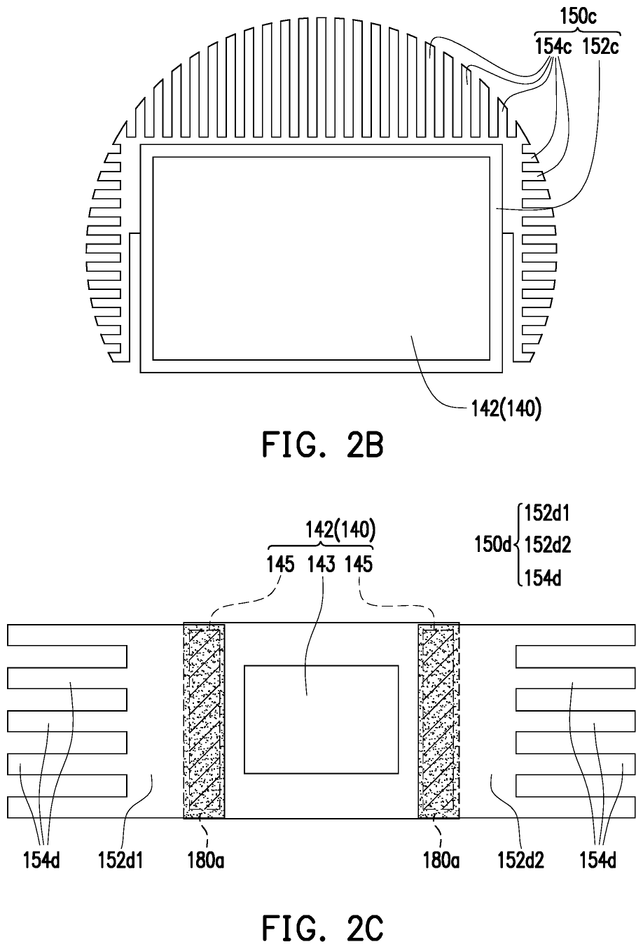

FIG. 3A is a schematic diagram of an optical engine module according to an embodiment of the invention. FIG. 3B is a schematic diagram of an optical engine heat dissipation module connected to the optical engine module of FIG. 3A according to an embodiment of the invention. Referring to FIG. 1C and FIG. 3A at the same time, a difference there between is that in the embodiment, a liquid crystal panel 142a includes a panel body 143a and a circuit board 145a. The panel body 143a is located on the circuit board 145a, and a plurality of pads 147a on the circuit board 145a are exposed by the panel body 143a. The pads 147a are bare copper regions on the circuit board 145a. Referring to FIG. 3A and FIG. 3B at the same time, a base 152e of an optical engine heat dissipation module 150e of the embodiment may be connected to the pads 147a through the thermal interface material 180b, thereby improving the heat dissipation efficiency. In other words, the projection apparatus of the embodiment may include the thermal interface material 180b disposed between the base 152e and the pads 147a for connecting the optical engine heat dissipation module 150e and the liquid crystal panel 142a. Since the circuit board 145a of the liquid crystal panel 142a that is in contact with the optical engine heat dissipation module 150e has a bare copper design (i.e., the pads 147a), the heat generated by the circuit board 145a may be transferred to the optical engine heat dissipation module 150e through the bare copper design (i.e., the pads 147a), so that the contact area with the optical engine heat dissipation module 150e may be increased to improve the heat dissipation efficiency.

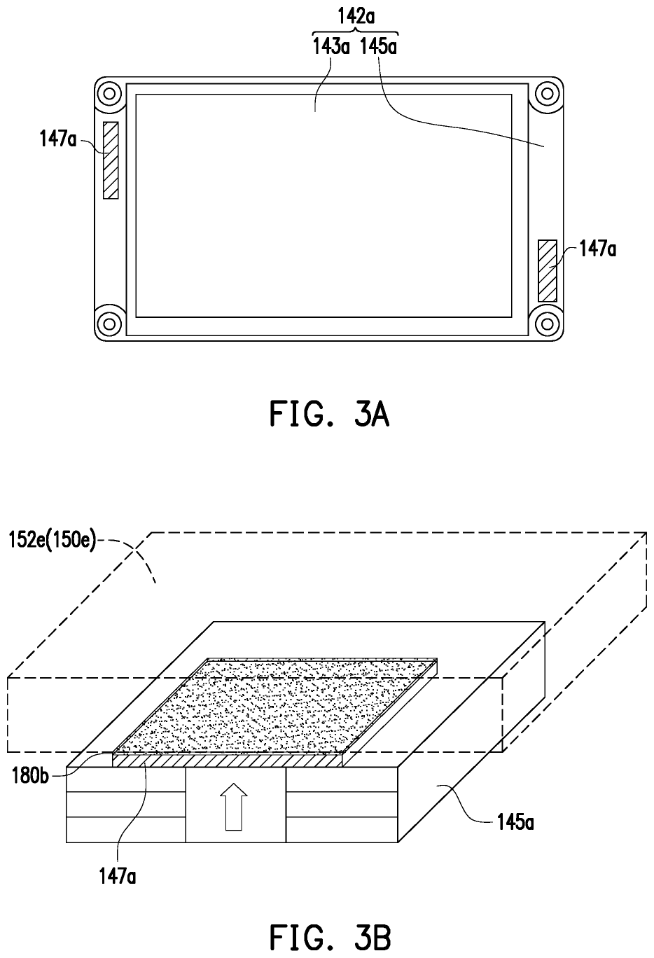

FIG. 4 is a schematic diagram of an optical engine module and an optical engine heat dissipation module according to another embodiment of the invention. Referring to FIG. 1C and FIG. 4 at the same time, a difference there between is that in the embodiment, an optical engine heat dissipation module 150f further includes a plurality of heat pipes 156f disposed on a base 152f. A plurality of heat dissipation fins 154f are directly connected to the heat pipes 156f, and are connected to the base 152f through the heat pipes 156f. Namely, the heat dissipation fins 154f are not directly connected to the base 152f, but indirectly connected to the base 152f through the heat pipes 156f. The base 152f of the optical engine heat dissipation module 150f is connected to upper and lower sides of the liquid crystal panel 142, so that the heat generated by the liquid crystal panel 142 may be evenly dispersed to the base 152f, which is a better heat dissipation design for the liquid crystal panel 142.

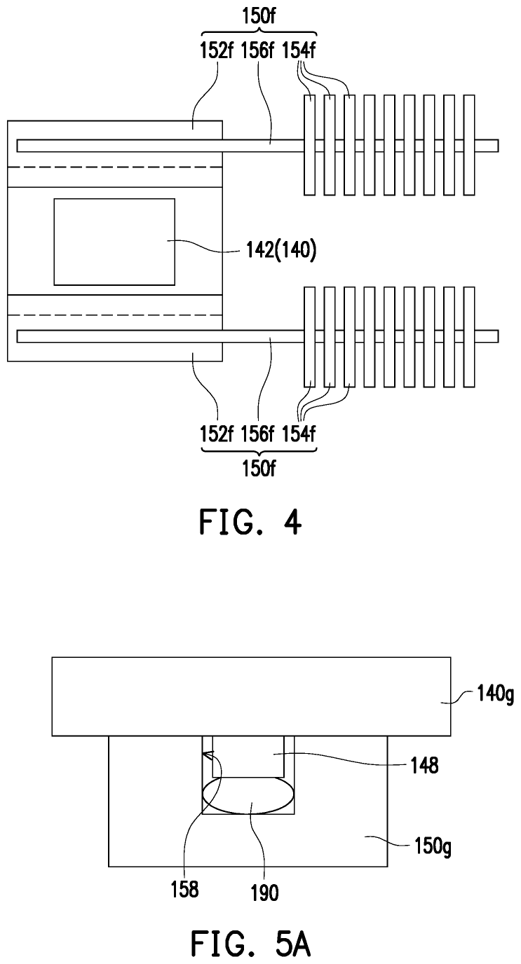

FIG. 5A is a partial cross-sectional schematic diagram of an optical engine module and an optical engine heat dissipation module according to another embodiment of the invention. FIG. 5B is a schematic front view of FIG. 5A. Referring to FIG. 5A and FIG. 5B at the same time, in the embodiment, an optical engine heat dissipation module 150g includes a base 152g and a plurality of heat dissipation fins 154g connected to the base 152g, where the heat dissipation fins 154g are directly connected to the base 152g. Lengths of the heat dissipation fins 154g are different, where extending directions of the heat dissipation fins 154g are perpendicular to at least a side of the frame of the liquid crystal panel 142, and the heat dissipation fins 154g are disposed in an arc shape.

Moreover, in order to ensure that the interior of the optical engine module 140g is not contaminated by external dust to affect the image quality, in the embodiment, the optical engine module 140g has a first sealing part 148, and the optical engine heat dissipation module 150g has a second sealing part 158. The first sealing part 148 and the second sealing part 158 are sealed so that when the optical engine module 140g is connected to the optical engine heat dissipation module 150g, dust is prevented from entering the optical engine module 140g from the outside to affect quality of the image generated by the liquid crystal panel 142. One of the first sealing part 148 and the second sealing part 158 is a groove, and the other one of the first sealing part 148 and the second sealing part 158 is a protrusion. FIG. 5A shows that the first sealing part 148 is embodied as a protrusion, and the second sealing part 158 is embodied as a groove, but the invention is not limited thereto.

In addition, preferably, the projection apparatus of the embodiment further includes a sealing ring 190, which is disposed between the first sealing part 148 and the second sealing part 158. The sealing ring 190 is, for example, an O-shaped ring, but the invention is not limited thereto. By using the first sealing part 148 of the optical engine module 140g to compress the sealing ring 190, the first sealing part 148 is more closely combined with the second sealing part 158, so as to achieve a better air-tight and dust-proof effect.

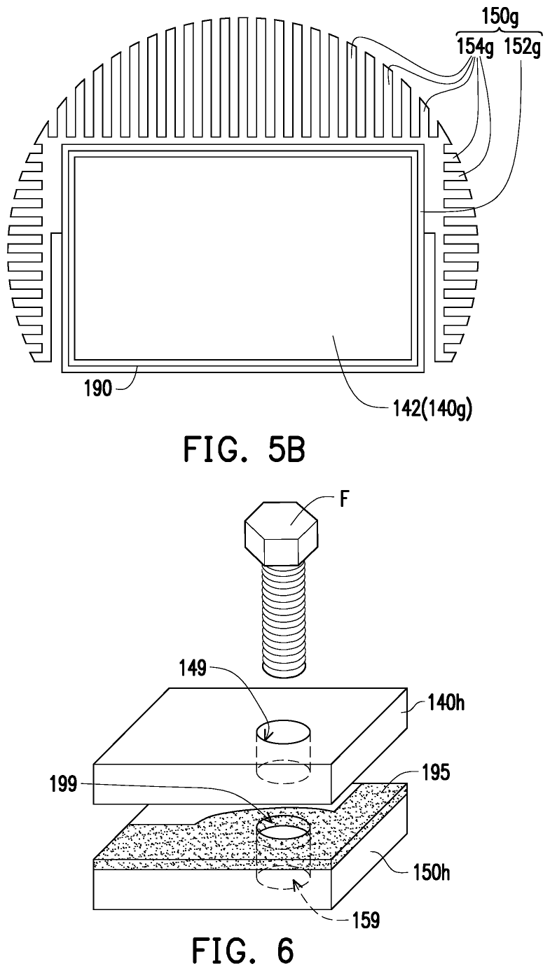

FIG. 6 is a schematic diagram of an optical engine module and an optical engine heat dissipation module according to another embodiment of the invention. Referring to FIG. 6, in order to ensure that the interior of an optical engine module 140h is not contaminated by external dust to affect the quality, the projection apparatus may include a buffer gasket 195 disposed between the optical engine module 140h and an optical engine heat dissipation module 150h. In detail, the optical engine module 140h has a first hole 149, the buffer gasket 195 has a second hole 199, and the optical engine heat dissipation module 150h has a third hole 159. A locking member F sequentially passes through the first hole 149, the second hole 199, and the third hole 159 to fix the optical engine module 140h on the optical engine heat dissipation module 150h. The locking member F is, for example, a screw or a bolt. Since contact surfaces of the optical engine module 140h, the optical engine heat dissipation module 150h, and the buffer gasket 195 are all planes, by using the locking member F to clamp the three parts, the buffer gasket 195 may be deformed due to pressure between the optical engine module 140h and the optical engine heat dissipation module 150h, so as to achieve the air-tight effect.

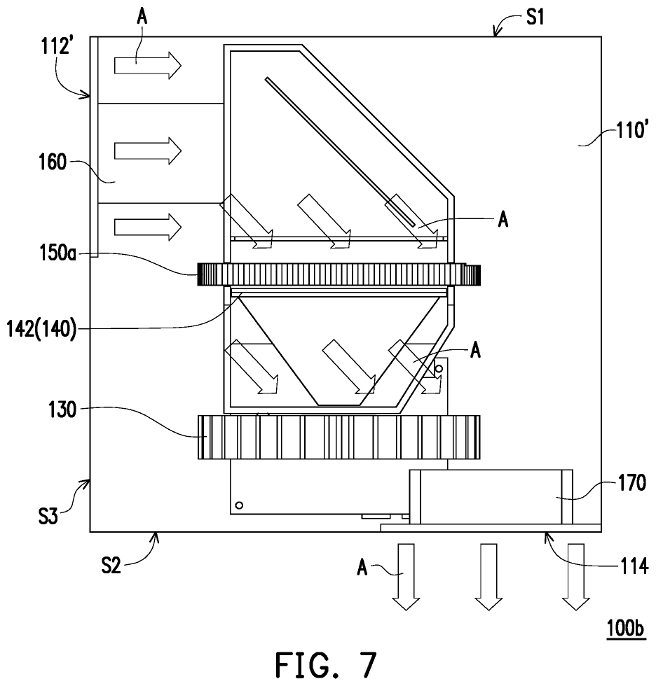

FIG. 7 is a schematic diagram of a projection apparatus according to another embodiment of the invention. Referring to FIGS. 1A and 7 at the same time, a difference there between is that in the embodiment, a position of an air inlet 112′ of a casing 110′ of a projection apparatus 100b is different from the position of the air inlet 112 of the casing 110 of FIG. 1A. In detail, the air inlet 112′ is disposed on the third side S3 of the casing 110′, and the air outlet 114 is disposed on the second side S2 of the casing 110′. The projection lens 160 is connected to the third side S3 of the casing 110′ and corresponds to the air inlet 112′. The airflow A may enter the casing 110′ from the air inlet 112′, and sequentially pass through the optical engine heat dissipation module 150a and the light source heat dissipation module 130 to flow out of the casing 110′ from the air outlet 114. Namely, the airflow A may flow through all of the heat dissipation modules in the projection apparatus 100b of the embodiment, so as to achieve the best heat dissipation effect.

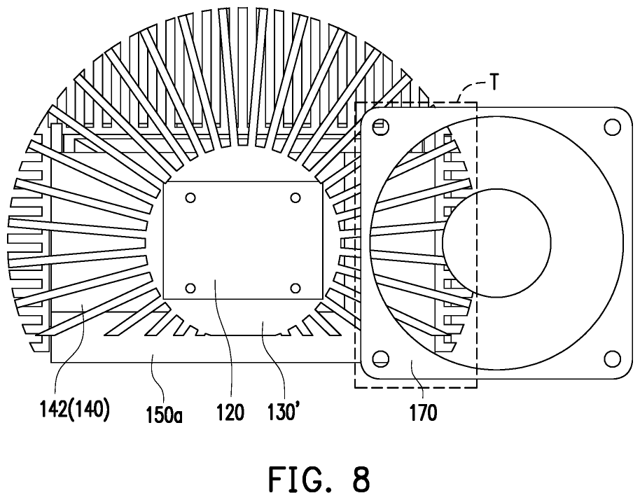

FIG. 8 is a schematic diagram of relative positions of a light source module, a light source heat dissipation module, an optical engine module, an optical engine heat dissipation module, and a fan according to another embodiment of the invention. Referring to FIG. 8, in the embodiment, the fan 170 has an axis. In a direction of the axial of the fan 170, a light source heat dissipation module 130′ and the optical engine heat dissipation module 150a are respectively overlapped with at least part of the fan 170, i.e. an intersection region T to facilitate smooth flowing of the airflow A, such that the overall projection apparatus may have the best flow field design.

In summary, the embodiments of the invention have at least one of the following advantages or effects. In the design of the projection apparatus of the invention, the optical engine heat dissipation module is connected to the liquid crystal panel of the optical engine module, and the light source module is connected to the light source heat dissipation module, so as the heat of the liquid crystal panel and the light source module can be dissipated through heat conduction, which improves heat dissipation efficiency of the overall projection apparatus. In addition, the airflow may enter the casing from the air inlet, pass through the optical engine heat dissipation module and the light source heat dissipation module in sequence, and flow out of the casing from the air outlet, which means that the airflow may flow through all of the heat dissipation modules in the projection apparatus of the invention, so as to achieve the best heat dissipation effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a casing, having an air inlet and an air outlet;
a light source module, disposed in the casing, and configured to provide an illumination beam;
a light source heat dissipation module, disposed in the casing, and connected to the light source module;
an optical engine module, disposed in the casing, located on a transmission path of the illumination beam, and configured to convert the illumination beam into an image beam, wherein the optical engine module comprises a liquid crystal panel;
an optical engine heat dissipation module, disposed in the casing, and connected to the liquid crystal panel, wherein airflow enters the casing from the air inlet, passes through the optical engine heat dissipation module and the light source heat dissipation module in sequence, and flows out of the casing from the air outlet; and
a projection lens, connected to the casing for projecting the image beam out of the casing.

2. The projection apparatus as claimed in claim 1, further comprising:
a fan, disposed in the casing, and located adjacent to the air outlet, wherein the airflow passes through the optical engine heat dissipation module, the light source heat dissipation module, and the fan in sequence, and flows out of the casing from the air outlet.

3. The projection apparatus as claimed in claim 2, wherein the fan comprises an axis, and in a direction of the axis of the fan, the light source heat dissipation module and the optical engine heat dissipation modules are respectively overlapped with at least part of the fan.

4. The projection apparatus as claimed in claim 1, wherein the optical engine heat dissipation module comprises a base and a plurality of heat dissipation fins connected to the base.

5. The projection apparatus as claimed in claim 4, wherein lengths of the heat dissipation fins are all equal, and an extending direction of the heat dissipation fins is perpendicular to at least a side of a frame of the liquid crystal panel.

6. The projection apparatus as claimed in claim 4, wherein lengths of the heat dissipation fins are all equal, and the heat dissipation fins are disposed radially on a frame of the liquid crystal panel while taking the liquid crystal panel as a center.

7. The projection apparatus as claimed in claim 4, wherein lengths of the heat dissipation fins are different, and an extending direction of the heat dissipation fins is perpendicular to at least a side of a frame of the liquid crystal panel.

8. The projection apparatus as claimed in claim 4, wherein an area of the base is greater than an area of the liquid crystal panel.

9. The projection apparatus as claimed in claim 4, wherein the liquid crystal panel comprises a panel body and a circuit board, the panel body is disposed on the circuit board, a plurality of pads on the circuit board are exposed by the panel body, and the base of the optical engine heat dissipation module is connected to the pads.

10. The projection apparatus as claimed in claim 1, wherein the optical engine heat dissipation module comprises a plurality of heat dissipation fins and a plurality of bases, the liquid crystal panel comprises a panel body and a plurality of metal blocks disposed on two opposite sides of the panel body, and the bases are connected to the metal blocks.

11. The projection apparatus as claimed in claim 10, wherein the heat dissipation fins are directly connected to the bases.

12. The projection apparatus as claimed in claim 10, wherein the optical engine heat dissipation module further comprises a plurality of heat pipes disposed on the bases, and the heat dissipation fins are directly connected to the heat pipes and connected to the bases through the heat pipes.

13. The projection apparatus as claimed in claim 10, further comprising:
a thermal interface material, disposed between the bases and the metal blocks.

14. The projection apparatus as claimed in claim 1, wherein the light source heat dissipation module comprises a base and a plurality of heat dissipation fins connected to the base, and the light source module is disposed on the base.

15. The projection apparatus as claimed in claim 1, wherein the optical engine module comprises a first sealing part, the optical engine heat dissipation module comprises a second sealing part, and the first sealing part and the second sealing part are sealed, so that the optical engine module is connected to the optical engine heat dissipation module.

16. The projection apparatus as claimed in claim 15, wherein one of the first sealing part and the second sealing part is a groove, and the other one of the first sealing part and the second sealing part is a protrusion.

17. The projection apparatus as claimed in claim 15, further comprising:
a sealing ring, disposed between the first sealing part and the second sealing part.

18. The projection apparatus as claimed in claim 1, further comprising:
a buffer gasket, disposed between the optical engine module and the optical engine heat dissipation module, wherein the optical engine module comprises a first hole, the buffer gasket comprises a second hole, the optical engine heat dissipation module comprises a third hole, and a locking member passes through the first hole, the second hole, and the third hole in sequence to fix the optical engine module on the optical engine heat dissipation module.

19. The projection apparatus as claimed in claim 1, wherein the casing comprises a first side and a second side opposite to each other, and a third side connected to the first side and the second side, wherein the air inlet is disposed on the first side, the air outlet is disposed on the second side, and the projection lens is connected to the third side.

20. The projection apparatus as claimed in claim 1, wherein the casing comprises a first side and a second side opposite to each other, and a third side connected to the first side and the second side, wherein the air inlet is disposed on the third side, the air outlet is disposed on the second side, and the projection lens is connected to the third side and corresponds to the air inlet.
